(19) United States
(12) Patent Application Publication
(10) Pub. No.: US 2007/0136726 A1
(43) Pub. Date: Jun. 14, 2007

(54) Tunable processor performance benchmarking

(76) Inventors: Gregory S. Freeland, Chandler, AZ (US); Joel L. Gross, Gilbert, AZ (US); Jose A. Laboy, Tempe, AZ (US)

Correspondence Address: MOTOROLA, INC., LAW DEPARTMENT, 1303 E. ALGONQUIN ROAD, SCHAUMBURG, IL, 60196, US

(21) Appl. No.: 11/301,237

(22) Filed: Dec. 12, 2005

(51) Int. Cl. G06F 9/46

(52) U.S. Cl. 718/100

(57) ABSTRACT

A tunable processor performance benchmarking method and system (100) estimates candidate software performance on a target processing environment (104) without porting the application. The candidate software's resource consumption is characterized to determine cache hit or miss rates. A test software generator (102) generates test software that is configured to have substantially the same cache miss rates and processor utilization, and its performance is measured when executing on the target processing environment (104). Instruction cache hit rates are maintained for the test software by selectively branching either within a routine (308, 310) that is resident in the instruction cache or to a routine (308, 310) that is not within the instruction cache. Data blocks (332, 334) are also selectively accessed in order to maintain a desired data cache miss rate.

### FIELD OF THE INVENTION

The present invention generally relates to the field of computer system performance benchmarking and more particularly to tunable computer system performance benchmarking techniques.

### BACKGROUND OF THE INVENTION

Various test suites aimed at benchmarking the performance of a processor system are available. These test suites include software applications that either run entirely out of the processor's cache or that run out of a fixed mixture of cache and memory. Suites that run entirely out of the processor's cache are limited to strictly evaluating the performance of the processor. These test suites are able evaluate the performance of the processor system for a particular application that runs out of cache or that has the same cache and memory mixture, but these test suites have limited utility in directly benchmarking a processing environment's performance with regards to a particular software package.

These test suites are limited since no benchmark test is ever completely representative of a particular custom application that a particular user is evaluating to be ported to a target system being tested. Therefore, the performance of the custom application on the target platform will largely be unknown until the system is built and the software is fully ported to that system. The lack of knowledge about application performance on the target platform can lead to costly hardware re-designs if the performance of the processor system is inadequate. If, on the other hand, the hardware performance is grossly over-adequate, this will lead to higher than necessary recurring hardware costs.

Therefore a need exists to overcome the problems with the prior art as discussed above.

### SUMMARY OF THE INVENTION

According to an embodiment of the present invention, a method for estimating processing resource consumption on a target processing environment includes characterizing, for a candidate software, a candidate processing resource consumption with respect to at least one processing resource on a base processing environment. The method further includes creating a test software that is configured to have a test software resource consumption that is substantially equal to the candidate processing resource consumption. The method further includes estimating, on the target processing environment, a target processing environment resource consumption for the candidate software by measuring resource consumption when executing the test software on the target processing environment.

According to another aspect of the present invention, a tunable processor performance benchmarking system includes a base processing environment performance monitoring component that characterizes a candidate processing resource consumption with respect to at least one processing resource for a candidate software on a base processing environment. The tunable processor performance benchmarking system further includes a test software creation component that creates a test software that is configured to have a test software resource consumption that is substantially equal to the candidate processing resource consumption. The tunable processor performance benchmarking system further includes a target system evaluation component that estimates a target processing environment resource consumption for the candidate software on the target processing environment by measuring resource consumption when executing the test software on the target processing environment.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a software development and target environment testing configuration in accordance with an exemplary embodiment of the present invention.

FIG. 2 illustrates a Central Processing Unit (CPU) and memory configuration according to an exemplary embodiment of the present invention.

FIG. 3 illustrates an expanded Central Processing Unit (CPU) and memory configuration according to an exemplary embodiment of the present invention.

FIG. 4 illustrates a tunable software benchmarking processing flow according to an exemplary embodiment of the present invention.

FIG. 5 illustrates a tunable software benchmarking test software execution flow according to an exemplary embodiment of the present invention.

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language).

Exemplary embodiments of the present invention advantageously provide an ability to characterize processing resource consumption of a candidate software package on a target processing environment without a need to port the entire candidate software package to the target processing environment. The exemplary embodiments create test software that is configured to simulate the processing resource consumption of the candidate software package. The test software is able to be created by replicating standard processing library functions into a sufficiently large software image so as to selectively create computer instruction cache misses when executing the test software. In general, however, any software module is able to be used by the exemplary embodiment to create the test software. The use of standard library function to create the test software facilitates porting of the test software to various target processing environments. These embodiments are particularly useful for software developers and processor manufacturers since developers are able to more easily evaluate the performance of developed candidate software on various target processing environments without a requirement to port the entire candidate software to each target processing environment being considered.

FIG. 1 illustrates a software development and target environment testing configuration 100 in accordance with an exemplary embodiment of the present invention. The software development and target environment testing configuration 100 of the exemplary embodiment includes a development processing environment 102 and a target processing environment 104. The software development and target environment testing configuration 100 of the exemplary embodiment further includes a target system evaluation component 110 that reads performance registers contained within the target processing environment 104 or otherwise monitors processing resource consumption on the target processing environment 104. The development processing environment 102 in this exemplary embodiment is a base processing environment that is used to develop a candidate software application. The development processing environment 102 includes an engineering workstation 106 and a development processing system 108. The development processing environment 102 of the exemplary embodiment includes various tools and features used to develop, test, optimize, and otherwise prepare the candidate software application for deployment. Further embodiments of the present invention utilize any suitable processing environment to characterize the candidate software application.

Once a candidate software application is developed on the development processing environment 102, the developer is able to port the candidate software application to a target processing environment 104. The target processing environment in the exemplary embodiment is one of the potential hardware platforms on which the candidate software application will execute when it is deployed. The target processing environment 104 of the exemplary embodiment is designed to minimize recurring costs and to optimize form factors of the hardware, and therefore lacks tools and other features to facilitate development, testing, and optimizing of the candidate software application. Although the development processing environment 102 is configured to emulate and/or simulate the target processing environment 104, the development processing environment 102 is not able to accurately characterize resource utilization of a candidate software application on the actual target processing environment 104. Porting of an actual software application from a development processing environment 102 to a target processing environment 104 requires additional work and time on the part of software developers and can increase cost.

The exemplary embodiment of the present invention allows a software developer to develop a candidate software application on the development processing environment 102. The development processing environment 102 includes a base processing environment performance monitoring component that characterizes a candidate processing resource consumption with respect to at least one processing resource for candidate software executing on the base processing environment 102. This characterization includes executing the candidate software application on the development processing environment 102 and monitoring resource consumption. Processing resources monitored by the exemplary embodiment include computer instruction cache hits and misses, data cache hits and misses, and processor capacity utilization. Further embodiments of the present invention are able to characterize any other processing resource consumption of a candidate software application.

Processing resource consumption is monitored and characterized in the exemplary embodiment through the use of performance registers within a base processing environment performance monitoring component of the development processing environment 102. For example, performance registers, or counters, internal to the development processing environment 102 count a number of instruction cache hits and misses, data cache hits and misses, and processor utilization percentages for an executing software application, as is described below. The values accumulated by these registers determine, for example, base data cache hit rates, base data cache miss rates, base instruction cache hit rate, the base instruction cache miss rates, and the base percentage of processor utilization.

Once a candidate software application is characterized, a test software creation component that is a part of the development processing system 108 of the exemplary embodiment creates a test software program that is to be executed by the target processing environment 104. The test software program created by the development processing system 108 of the exemplary embodiment ultimately has a code size that is larger than instruction cache blocks contained within a target processing environment 104. The exemplary embodiment of the present invention typically generates a smaller test program, such as a data file compression program, and replicates this smaller test program several times in memory to create a suitably large program to be executed on the target processing environment 104. In the exemplary embodiment of the present invention, the smaller test program is configured to be replicated during runtime on the target processing environment 104 in order to achieve the desired resource consumption. Further embodiments of the present invention are able to replicate the smaller test program at any time prior to execution on the target processing environment 104, such as prior to loading onto the target processing environment, or yet further embodiments create a large test program initially. The created test software program is also configured to have a test software resource consumption that is substantially equal to the candidate processing resource consumption. This configuration is achieved through the use of configurable resource utilization configuration parameters, as is described below.

The created test software program is then loaded and executed on the target processing environment 104. A target system evaluation component 110, which is connected to the target processing environment 104 in the exemplary embodiment, reads internal performance registers contained within the target processing environment 104 to measure resource consumption by the executing test software program on the target processing environment 104. In further embodiments, the target system evaluation component 110 includes circuitry to directly or indirectly monitor the signals or other features of the target processing environment to measure processing resource consumption.

Although the above example describes the development of the candidate software application and evaluation of resource consumption on a target processing environment, some embodiments of the present invention support characterization of already developed candidate software that is able to execute on its original processing environment. In evaluating the porting of already deployed candidate software for hosting on another processing environment, the resource consumption of the candidate software is able to be characterized in its original processing environment and test software that emulates that resource consumption is created and executed on a new target processing environment. The test software program is then executed on that new target environment and calibrated or tuned to exhibit behavior substantially similar to that of the original application on the original hardware. The target environment is also able to be monitored during execution of the test software program to estimate the resource consumption of the candidate software on the new target environment. Although this exemplary embodiment discusses the development and deployment of software applications, some embodiments of the present invention are applicable to any type of software, such as operating systems, device drivers, and any other software to be executed by a processing environment.

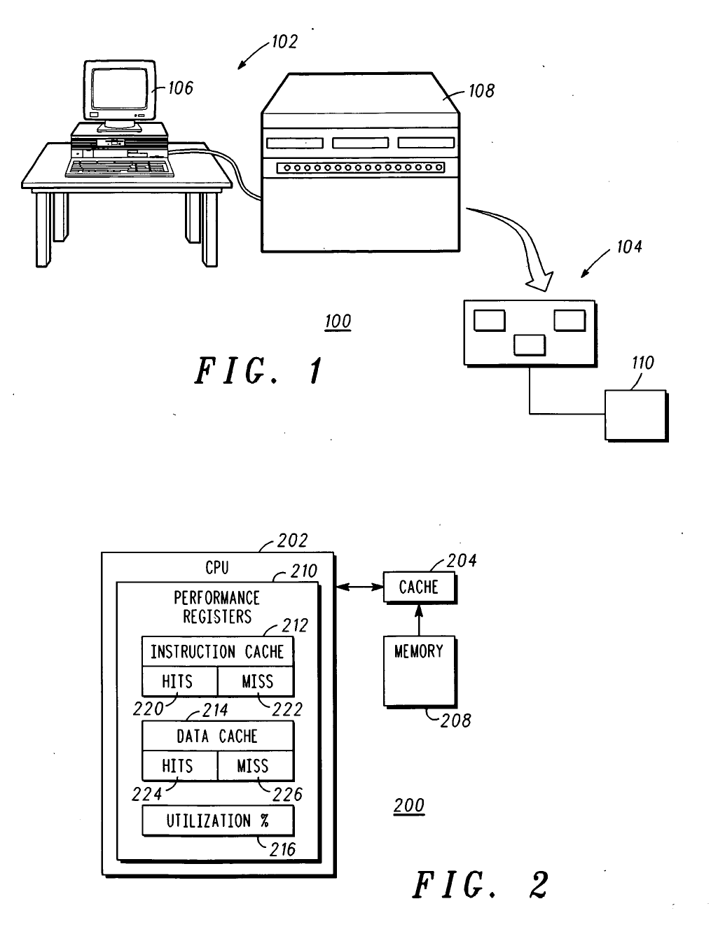

FIG. 2 illustrates a Central Processing Unit (CPU) and memory configuration 200 according to an exemplary embodiment of the present invention. The CPU and memory configuration 200 is representative of processing resources contained in both the development processing environment 102 and the target processing environment 104 of the exemplary embodiment. The CPU and memory configuration 200 of the exemplary embodiment shows a CPU 202 with a set of performance registers 210. Performance registers 210 include registers that store events related to CPU and other processing environment operations. CPU 202 of the exemplary embodiment includes computer instruction cache performance registers 212, data cache performance registers 214, and processor utilization percentage register 216. The computer instruction cache performance register 212 includes a computer instruction cache hit event register 220, a computer instruction cache miss event register 222, a data cache hit event register 224, and a data cache miss event register 226. The performance registers 212 of the exemplary embodiment further include a processor utilization percentage register 216 that stores the percentage of available time that the CPU is used for executing software. Furthermore, many more performance measures exists over and beyond those mentioned above and it should be understood that these are other performance measures that can be performed using embodiments of the present invention.

The CPU 202 further communicates with a cache 204. Memory 208 includes computer instructions that define, for example, a complete candidate software application or a test software program. Memory 208 further includes a complete set of data that software applications access in their processing.

The cache 204 of the exemplary embodiment includes a separate computer instruction cache and a separate data cache. Cache 204 is a high speed computer instruction and data storage device that allows faster access and modification to stored data than memory 208. CPU 202 of the exemplary embodiment accesses computer instructions and data within cache 204. When the CPU 202 of the exemplary embodiment accesses computer instructions or data that is not present in cache 204, a “cache miss” occurs and the operation of cache 204 retrieves the required computer instructions or data from memory 208 and stores the required computer instructions or data into cache 204. Cache 204 of the exemplary embodiment is organized into cache blocks according to conventional techniques. It is clear that embodiments of the present invention are able to operate with any cache architectures; including caches that are not divided into uniform blocks but rather dynamically manage cached data. Cache 204 of the exemplary embodiment may discard previously used computer instructions or data that had been stored in the cache 204 in order to make room for the newly required computer instructions or data. The computer instruction cache miss register 222 is incremented each time such a cache miss occurs. If, on the other hand, the CPU 202 is accesses a computer instruction that is already stored in cache 204, a “cache hit” event occurs that causes the computer instruction cache hit register 220 to increment.

An executing software application is able to access and manipulate data stored in memory 208. Cache 204 similarly caches data from memory 208. As described above with respect to accessing computer instructions, the CPU 202 is able to access data that is either already stored in cache 204, which results in a data cache hit that is reflected by incrementing the data cache hit register 224. Data is also stored in cache 204 of the exemplary embodiment of the present invention in data cache blocks. If the processing of CPU 202 accesses data that is not already in cache 204, a data cache miss occurs. Upon a data cache miss, the required data is retrieved from memory 208 and stored in cache 204. The data cache miss register 226 is correspondingly incremented. As with computer instructions, data already stored in cache 204 may be discarded to make room for this new data.

FIG. 3 illustrates an expanded Central Processing Unit (CPU) and memory configuration 300 according to an exemplary embodiment of the present invention. The expanded Central Processing Unit (CPU) and memory configuration 300 illustrates the logically separate computer instruction cache 304 and data cache 320, as well as the separate sections of computer instruction memory 306 and data memory 330. Cache memory architectures in some CPUs are able to be thought of as logically divided as described herein. It is to be understood that any cache architecture, which may or may not include partitioned or unified cache memory blocks, is able to be used by various embodiments of the present invention. In order to improve the clarity of the explanation of the exemplary embodiment of the present invention, the expanded Central Processing Unit (CPU) and memory configuration 300 illustrates a simplified example of the contents of instruction memory 306 and data memory 330.

Computer instruction memory 306 is shown to include an exemplary test software program that includes two processing modules or routines, routine 1 308 and routine 2 310. The inclusion of two processing routines is illustrated here to simplify the present description and is not a limitation or requirement upon the architecture of test software utilized by various embodiments of the present invention. It is clear that further embodiments of the present invention are able to use any number of routines and or procedures of various sizes and that branch to different program locations according to the designs of those alternative embodiments. In the exemplary embodiment, the processing modules, e.g., routine 1 308 and routine 2 310, are processing routines implementing an algorithm within a software library.

The code size of the two routines of this exemplary test software, as measured by the number of data storage locations occupied by the executable code of these routines, is selected to be slightly smaller than the size storage available in the computer instruction cache 304 after other components are loaded, such as the test software executive 346, described in detail below. This relationship between routine size and computer instruction cache size results in one routine being able to be resident in the computer instruction cache 304 at a time, but both routines are not able to be resident in the computer instruction cache at the same time. As described above, the exemplary test software is able to be generated by a “smart replication” capability performed at runtime on the target processing environment to achieve the desired cache footprint. A gap 350 is shown to be located between routine 1 308 and routine 2 310 in this exemplary embodiment to ensure that the respective start of the first routine and the start of the second routine are separated from one another in instruction memory by a distance larger than the size of the instruction cache. Embodiments of the present invention create test software programs that have the start of a first routine separated from the end of the second routine by a distance larger than the size of the instruction cache.

The ability of computer instruction cache 304 to contain one routine but not both routines allows selecting whether a cache hit or miss will occur after execution of an iteration of a routine. Computer instruction cache 304 is shown to include one routine N 348, which in this simplified example is either routine 1 308 or routine 2 310 that are stored in computer instruction memory 306. As described above, these multiple routines are replicated according to user provided configuration data in the exemplary embodiment at runtime. Computer instruction cache 304 is also shown to include a test software executive 346, which controls execution of the test software program of this example. In this illustrated example, routine 1 308 is resident in the computer instruction cache 304. This is caused by CPU 202 executing routine 1 308 and having loaded routine 1 308 into computer instruction cache 304. In this example, once routine 1 308 finishes executing, control returns to the test software executive 346 which performs a decision 340 of whether a computer instruction cache hit or miss should occur. This decision is based on the desired behavior which is configurable and defined to be substantially similar to that of the original application. As described below, the test software program of the exemplary embodiment that is used to characterize resource consumption on a target processing environment is able to be configured to have a desired number of cache hits per a given number of computer instructions. If a cache hit is to occur, i.e., if computer instructions are to be read from the computer instruction cache 304 without accessing computer instruction memory, a “hit” branch 344 executes after decision 340 so that another iteration of program code that is already resident in the computer instruction cache 304, i.e., a branch to a location within routine 1 308, is performed. If a computer instruction cache miss is to occur, a “miss” branch 342 is executed after decision 340 to cause CPU 202 to access computer instructions within routine 2 310 and to perform an iteration of routine 2 310. Since routine 2 310 is not resident in computer instruction cache 304, the computer instruction cache 304 operates to replace routine 1 308 in the computer instruction cache 304 with routine 2 310. Cache hit and miss rates for an executing test software program are able to be configured by configuring either one or both of an instruction cache hit configuration parameter or an instruction cache miss configuration parameter. These parameters are configured based upon either one or both of the base instruction cache hit rate or the base instruction cache miss rate that was determined for the candidate software.

The expanded CPU and memory configuration 300 further illustrates a data cache 320 and data memory 330. Data memory 330 in this simplified example is shown to include two data blocks, data 1 332 and data 2 334. Each of these two data blocks are chosen to have a size that allows one of these data blocks, but not both simultaneously, to be stored in data cache 320.

Data cache 320 is shown to include a configuration data block 322 and a data N data block 324. Configuration data block 322 includes configuration values defining the configuration for the operation of the test software program being executed by CPU 202. The configuration data block 322 includes, for example, data defining the rate of computer instruction cache hits and misses, the rate of data cache hits and misses, and the percent of processor utilization that is to be used for the test software program. The data stored within configuration data block 322 is established by the development processing environment 102 in the exemplary embodiment and stored as either part of the test program stored in instruction memory 306 or as part of data stored in data memory 330 when loaded onto the target processing environment 104.

The test software program of this exemplary embodiment is configured to process and/or perform manipulation of data stored within data memory 330. The processing of the test software program can select between accessing data stored within either the data block that is currently being processed or accessing data stored within another data block. In this example, since the two data blocks is selected to fit one but not two such data blocks within the data cache 320, accessing data within the same data block will cause a data cache hit and accessing data within another data block will cause a data cache miss. For example, the test software program is able to initially manipulate data within data block 1 332 for a specified number of data accesses, and then switch to access data that is within data block 2 334. This switching of data blocks triggers a data cache miss and causes data block 2 334 to be loaded into data cache 320. The processing then continues to manipulate data from within data block 2 334, which is now loaded into data cache 320, to cause data cache hits. Switching between data block 1 332 and data block 2 334 is performed according to the number of data cache hits and/or misses that are to be performed by the test software program according to configuration data stored in the configuration data block 322. This configuration data is set based upon the base data cache hit rate or the base data cache miss rate determined for the candidate software. The exemplary embodiment includes processing algorithms in the test software program that access data in data blocks, such as data block 1 332 or data block 2 334, that are indicated by a data pointer that points to the top of those data blocks. The test software executable 346 of the exemplary embodiment is able to change that pointer to reference either data block 1 332 or data block 2 334 to change which data block is accessed, and to thereby trigger a data cache miss.

The data contained within data block 1 332 and data block 2 334 are stored within data memory 330 at locations that are separated by a size greater than the size of the data cache 320 of the exemplary embodiment. Storing these two data blocks in such a manner ensures that a data cache miss occurs when changing the processing to access one data block and then the other. The test software created by the exemplary embodiment of the present invention further includes a data cache hit configuration parameter or a data cache miss configuration parameter, that is stored within the configuration data block 322, that configures a data cache hit rate or a data cache miss rate based upon the base data cache hit rate or the base data cache miss rate that was determined for the candidate software executing on the base processing environment 102. When executing on the target processing environment 104, the test software alternates its accessing of either data block 1 332 or the data block 2 334 based upon the data cache hit configuration parameter or the data cache miss configuration parameter.

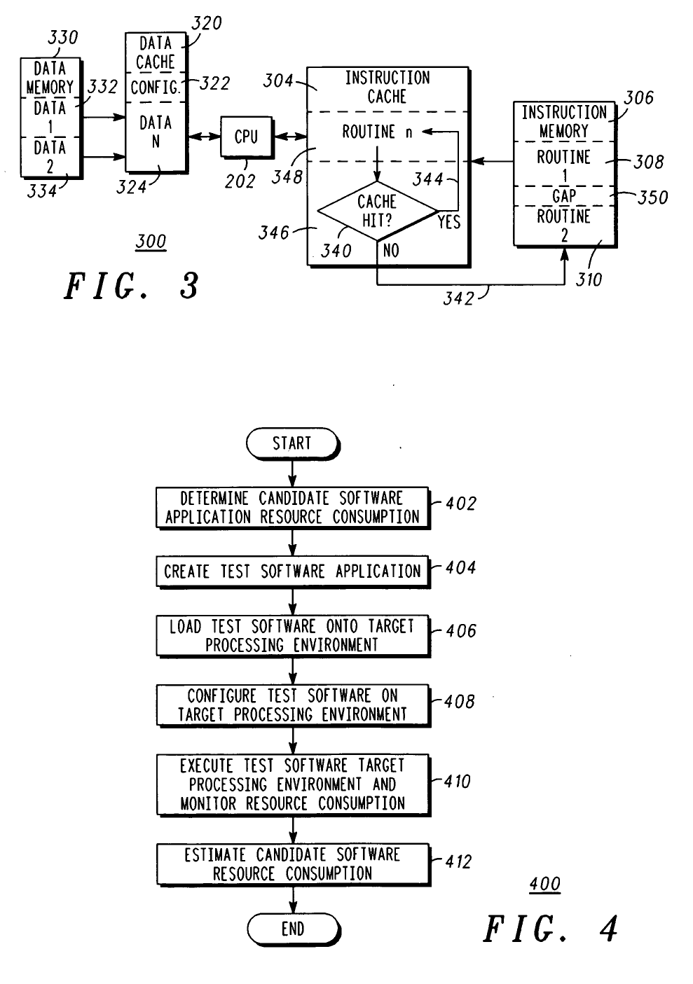

FIG. 4 illustrates a tunable software benchmarking processing flow 400 according to an exemplary embodiment of the present invention. The tunable software benchmarking processing flow 400 begins by determining, at step 402, a candidate software application resource consumption. As described above, the resource consumption of the candidate software application is performed by observing performance registers contained within the base processing environment.

The tunable software benchmarking processing flow 400 of the exemplary embodiment continues by creating, at step 404, a test software program. Creation of the test software program in the exemplary embodiment includes assembling a number of processing routines implementing an algorithm of software library routines. The exemplary embodiments create test software by assembling routines found in standard library algorithms, such as a “zlib” routine that compresses a data memory block. The assembled routines can be simply replications of a single standard library algorithm or assemblies of one or more copies of different routines. The test software program is created so as to have a size that is greater than the computer instruction cache size of the target processing environment to ensure that cache misses can be triggered by branching to a suitably distant computer instruction location within the test software program.

The tunable software benchmarking processing flow 400 continues by loading, at step 406, the test software program onto the target processing environment. Some embodiments require a re-compilation, linking, creation of read-only memory encoded with the program, and other preparation of the test software program as part of this loading. The processing continues by configuring, at step 408, the test software on the target processing system. This configuration is performed in the exemplary embodiment by storing configuration parameters into the configuration data block 322. Some embodiments of the present invention perform this configuration step as part of the create test software step 404 by, for example, hard-coding configuration parameters, such as cache hit and miss rates, into the test software program.

The tunable software benchmarking processing flow 400 continues by executing, at step 410, the test software program on the target processing environment 104 and monitoring its resource consumption. Resource consumption is monitored in the exemplary embodiment by, for example, reading performance register values through debugging ports, through circuit emulation interfaces, or through other interfaces. The processing then estimates, at step 412, the resource consumption of the candidate software on the target processing environment. In the exemplary embodiment, this estimate is directly provided by the resource consumption of the test software program on the target processing environment. Further embodiments are able to include scaled test software programs that may require further analysis of the resource consumption of the test software program to estimate the resource consumption of the candidate software application. The processing then terminates.

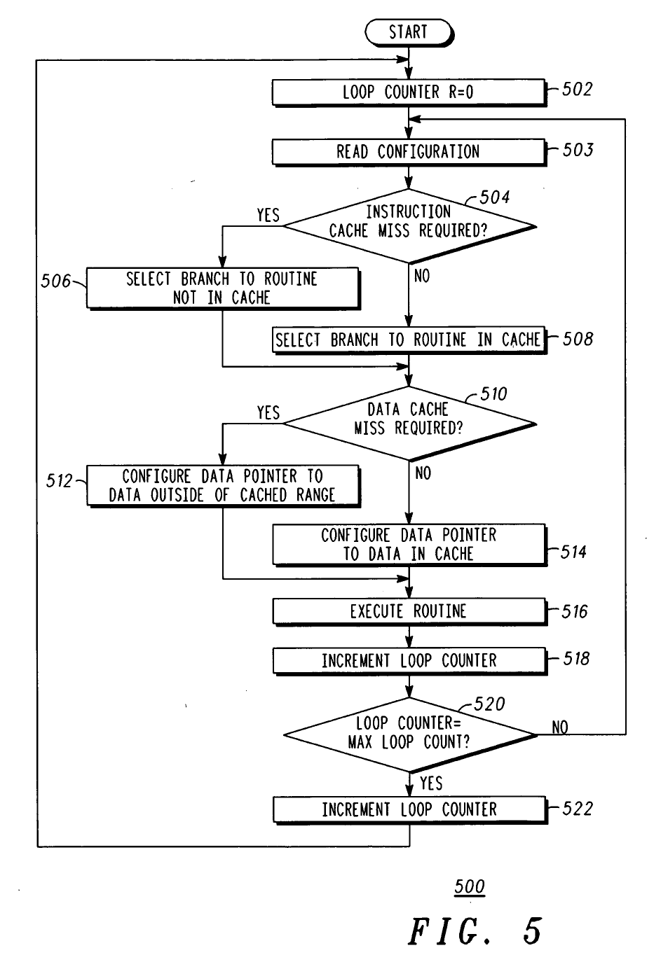

FIG. 5 illustrates a tunable software benchmarking test software execution flow 500 according to an exemplary embodiment of the present invention. The tunable software benchmarking test software execution flow 500 begins by setting, at step 502, a loop counter to zero. The processing next reads, at step 503, the configuration data for the test software program to properly configure cache hits and misses as well as required processing utilization. The processing continues by determining, at step 504, if an instruction cache miss is required. If an instruction cache miss is required, the processing continues by selecting, at step 506, a branch to a routine that is not stored in the computer instruction cache. In the exemplary embodiment, this branch is selected to be to a routine that is located in the executable code at a distance that is greater than the size of the computer instruction cache of the target processing environment. If an instruction cache miss is not required, the processing continues by selecting, at step 508, a branch to a routine that is stored in the computer instruction cache. In the exemplary embodiment, this branch is selected to be to a location that is in a routine that was recently executed.

The processing then continues by determining, at step 510, if a data cache miss is required. If a data cache miss is required, the processing continues to configuring, at step 512, the data pointer used by the test software program to access data to manipulate to point to data that is outside of the data memory range that is resident within data cache 320. If a data cache miss is not required, the processing continues to configuring, at step 514, the data pointer used by the test software program to access data to manipulate to point to data that is within the data memory range that is resident within data cache 320. In the exemplary embodiment, this configuration is performed by not changing the data pointer value.

The processing continues by executing, at step 516, the routine that was selected above. After execution of the routine, the processing increments, at step 518, the value of the loop counter. The exemplary embodiment of the present invention includes a loop counter that is used to adjust the percentage of processor utilization consumed by the test software program. In the exemplary embodiment, a number of iterations of the routine being executed are performed prior to executing a delay in processing. A delay in processing, described below, is performed by placing the processor into a “sleep” mode. In the exemplary embodiment, any background “idle” processes are halted so that the processor is placed into a sleep mode during the delay time. Further embodiments of the present invention do not implement this delay in processing and just continually execute the test software. Some embodiments that do not utilize a processing delay to vary processor utilization do not maintain a loop counter.

The processing then determines, at step 520, if the loop counter is equal to the maximum loop count value. The maximum loop count value is selected, in combination with the number of instructions executed by each iteration of the selected routine, to cause a required number of instructions to execute prior to placing the processor into a sleep mode during a pre-configured delay time. These values are selected in the exemplary embodiment based upon the base percentage of processor utilization determined for the candidate software and the resulting percentage of processor utilization to be used for the test software.

If the loop counter is not equal to the maximum loop count value, the processing returns to reading, at step 503, the configuration data and continues with the subsequent processing described above. Re-reading the configuration data allows the configuration of the test software program to by dynamically adjusted in the exemplary embodiment. If the loop counter is determined to be equal to the maximum loop count value, the processing halts for a delay, at step 522. After the delay of step 522 expires, the processing returns to setting, at step 502, the loop counter to zero and continues with the subsequent processing described above

The present invention can be realized in hardware, software, or a combination of hardware and software. A system according to an exemplary embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein.

The present invention can also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following a) conversion to another language, code or, notation; and b) reproduction in a different material form.

Each computer system may include, inter alia, one or more computers and at least one computer readable medium that allows the computer to read data, instructions, messages or message packets, and other computer readable information. The machine readable medium may include non-volatile memory, such as ROM, Flash memory, Disk drive memory, CD-ROM, and other permanent storage. Additionally, a computer medium may include, for example, volatile storage such as RAM, buffers, cache, and network circuits. Furthermore, the computer readable medium may comprise computer readable information in a transitory state medium such as a network link and/or a network interface, including a wired network or a wireless network, that allow a computer to read such computer readable information.

The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

Reference throughout the specification to “one embodiment” means that a particular feature, structure, or characteristic described in connection with the embodiment is included in at least one embodiment of the present invention. Thus, the appearances of the phrases “in one embodiment” in various places throughout the specification are not necessarily all referring to the same embodiment. Furthermore, the particular features, structures, or characteristics may be combined in any suitable manner in one or more embodiments. Moreover these embodiments are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in the plural and visa versa with no loss of generality.

While the various embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method for estimating processing resource consumption on a target processing environment, the method comprising:
characterizing, for a candidate software application, a candidate processing resource consumption with respect to at least one processing resource on a base processing environment;
creating a test software program that is configured to have a test software resource consumption that is substantially equal to the candidate processing resource consumption; and
estimating, on the target processing environment, a target processing environment resource consumption for the candidate software by measuring resource consumption when executing the test software on the target processing environment.

2. The method according to claim 1, wherein the at least one processing resource comprises at least one of program memory cache misses, data memory cache misses, program memory cache hits, data memory cache hits, or processor utilization.

3. The method according to claim 1, wherein the creating creates the test software program that is configured to replicate at least one software module while executing on the target processing environment.

4. The method according to claim 1, wherein the base processing environment comprises at least one performance register and wherein the characterizing comprises reading the at least one performance registers of the base processing environment.

5. The method according to claim 4, wherein the target processing environment comprises at least one performance register and wherein the estimating comprises reading the at least one performance registers of the target processing environment.

6. The method according to claim 1,
wherein the characterizing comprises determining a base data cache hit rate or a base data cache miss rate for the candidate software executing on the base processing environment,
wherein the test software accesses data in a first data block and a second data block, wherein the first data block and the second data block each have a respective data size smaller than or equal to a data cache block of the target processing environment and are stored within a data memory at locations that are separated by a size greater than a size of a data cache block of the target processing environment,
wherein the test software comprises at least one of a data cache hit configuration parameter or a data cache miss configuration parameter to configure a data cache hit rate or a data cache miss rate based upon the base data cache hit rate or the base data cache miss rate, and
wherein the estimating selects accessing either the first data block or the second data block based upon the data cache hit configuration parameter or the data cache miss configuration parameter.

7. The method according to claim 1,
wherein the characterizing comprises determining at least one of a base instruction cache hit rate or a base instruction cache miss rate for the candidate software executing on the base processing environment,
wherein the test software iteratively executes a first processing module and a second processing module within the composite test software, wherein the first processing module and the second processing module each have an instruction code size smaller than or equal to the size of the instruction cache block and wherein the start of the first processing module and the end of the second processing module are separated from one another in instruction memory by a distance larger than the size of the instruction cache block,
wherein the composite test software comprises an instruction cache hit configuration parameter or an instruction cache miss configuration parameter to configure an instruction cache hit rate or an instruction cache miss rate that is configured based upon one of the base instruction cache hit rate or the base instruction miss rate, and
wherein the estimating selects executing iterations of either the first processing module or the second processing module based upon the instruction cache hit configuration parameter or the instruction cache miss configuration parameter.

8. The method according to claim 7, wherein the first processing module and the second processing module consists of processing routines implementing an algorithm within a software library.

9. The method according to claim 7, wherein the characterizing comprises determining a base percentage of processor utilization for the candidate software executing on the base processing environment, and
wherein the method further comprising performing a processing delay between at least some iterations of the first processing module or the second processing module based upon the percentage of processor utilization.

10. A tunable processor performance benchmarking system comprising:
a base processing environment performance monitoring component that characterizes a candidate processing resource consumption with respect to at least one processing resource for a candidate software on a base processing environment;
a test software creation component that creates a test software that has a code size larger than an instruction cache block contained within a target processing environment, the test software configured to have a test software resource consumption that is substantially equal to the candidate processing resource consumption; and
a target system evaluation component that estimates a target processing environment resource consumption for the candidate software on the target processing environment by measuring resource consumption when executing the test software on the target processing environment.

11. The tunable processor performance benchmarking system according to claim 10, wherein the base processing environment performance monitoring component comprises at least one of a program memory cache miss counter, a data memory cache miss counter, a program memory cache hit counter, a data memory cache hit counter, or processor utilization counter.

12. The tunable processor performance benchmarking system according to claim 10, wherein the base processing environment performance monitoring component comprises at least one performance register that is read when characterizing the candidate processing resource consumption.

13. The tunable processor performance benchmarking system according to claim 12, wherein the target processing environment comprises at least one performance register and wherein the target system evaluation component reads the at least one performance register of the target processing environment.

14. The tunable processor performance benchmarking system according to claim 10,
wherein the base processing environment performance monitoring component further determines a base data cache hit rate or a base data cache miss rate for the candidate software executing on the base processing environment, and
wherein test software creation component creates the test software that accesses data in a first data block and a second data block, wherein the first data block and the second data block each have a respective data size smaller than or equal to a data cache block of the target processing environment and are stored within a data memory at locations that are separated by a size greater than a size of a data cache block of the target processing environment, wherein the composite test software comprises a base data cache hit rate or a base data cache miss rate to configure a data cache hit rate or a data cache miss rate based upon the base data cache hit rate or the base data cache miss rate.

15. The tunable processor performance benchmarking system according to claim 10,
wherein the base processing environment performance monitoring component further determines a base instruction cache hit rate or a base instruction cache miss rate for the candidate software executing on the base processing environment, and
wherein the test software creation component creates the test software that iteratively executes a first processing module and a second processing module within the composite test software, wherein the first processing module and the second processing module each have an instruction code size smaller than or equal to the size of the instruction cache block and wherein the start of the first processing module and the end of the second processing module are separated from one another in instruction memory by a distance larger than the size of the instruction cache block, wherein the composite test software comprises an instruction cache hit configuration parameter or an instruction cache miss configuration parameter to configure an instruction cache hit rate or an instruction cache miss rate that is configured based upon the base instruction cache hit rate or the base instruction cache miss rate.

16. The tunable processor performance benchmarking system according to claim 15, wherein the test software creation component creates the test software with the first processing module and the second processing module consisting of processing routines implementing an algorithm within a software library.

17. A machine readable medium containing a machine readable program that estimates processing resource consumption on a target processing environment, the machine readable program comprising instructions for:
characterizing, for a candidate software application, a candidate processing resource consumption with respect to at least one processing resource on a base processing environment;
creating a test software program that is configured to have a test software resource consumption that is substantially equal to the candidate processing resource consumption; and
estimating, on the target processing environment, a target processing environment resource consumption for the candidate software by measuring resource consumption when executing the test software on the target processing environment.
